(19) United States
(12) Patent Application Publication
(10) Pub. No.: US 2023/0351272 A1
(43) Pub. Date: Nov. 2, 2023

(54) AIRCRAFT RESERVATION SYSTEM

(71) Applicant: HONDA MOTOR CO., LTD., Tokyo (JP)

(72) Inventor: Yutaka Yoshida, Wako-shi (JP)

(21) Appl. No.: 18/173,198

(22) Filed: Feb. 23, 2023

(30) Foreign Application Priority Data
Mar. 31, 2022 (JP) 2022-059470

(51) Int. Cl. G06Q 10/02

(52) U.S. Cl. CPC G06Q 10/02

(57) ABSTRACT

An aircraft reservation system includes: a reservation reception unit that receives a reservation for a flight from a user; a recommended flight extraction unit that extracts a recommended flight that has a departure location and an arrival location same as a selected flight, a scheduled departure date and time or a scheduled arrival date and time with a difference of not more than a predetermined time from a scheduled departure date and time or a scheduled arrival date and time of the selected flight, and a lower price than the selected flight, and that is available to book, the selected flight being a flight selected by the user, the selection being received by the reservation reception unit; and a display control unit that displays, on a display unit, a comparison screen displaying the price of the selected flight and the price of the recommended flight.

### INCORPORATION BY REFERENCE

The present application claims priority under 35 U.S.C.§119 to Japanese Patent Application No.2022-059470 filed on Mar. 31, 2022. The content of the application is incorporated herein by reference in its entirety.

### BACKGROUND OF THE INVENTION

### Field of the Invention

The present invention relates to an aircraft reservation system.

### Description of the Related Art

Conventionally, there has been proposed a system in which an unspecified-time airline ticket for a flight of which departure time has not been determined is provided at a discount to a user, and an airline company, before departure, selects a flight to which the unspecified-time airline ticket is allocated to make the ticket usable, and gives notice to the user (see, for example, Japanese Translation of PCT International Application Publication No. 2001-509622).

### SUMMARY OF THE INVENTION

In the conventional system, for the airline company, selecting an aircraft for which an unspecified-time airline ticket is made usable brings an advantage of being able to fill the seats of the aircraft. However, in recent years, the spread of communication terminals such as smart phones allows a user to operate a communication terminal to access a flight reservation site, and directly make a reservation. Therefore, there is room for improvement in supporting reservations so that both flight operators and users can benefit.

The present invention has been made in view of such a background, and an object of the present invention is to provide an aircraft reservation system that supports flight reservations so that both flight operators and flight users can benefit.

As an aspect for achieving the above object, proposed is an aircraft reservation system including: a reservation reception unit that receives a reservation for a flight from a user; a recommended flight extraction unit that refers to a flight database in which flight plans, reservation status, and prices of flights are recorded, and extracts a recommended flight that has a departure location and an arrival location same as a selected flight, a scheduled departure date and time or a scheduled arrival date and time with a difference of not more than a predetermined time from a scheduled departure date and time or a scheduled arrival date and time of the selected flight, and a lower price than the selected flight, and that is available to book, the selected flight being a flight selected by the user, the selection being received by the reservation reception unit; and a display control unit that displays, on a display unit which is visually recognized by the user, a comparison screen displaying, in a comparable manner, the price of the selected flight and the price of the recommended flight.

The above aircraft reservation system may include an available reservation time range setting unit that sets an available reservation time range including the scheduled arrival date and time of the recommended flight, wherein the display control unit may be configured to display, on the display unit, the comparison screen displaying, in a comparable manner, the price of the selected flight and a time-range-specified flight price at which a reservation for the recommended flight is arranged in response to specifying the available reservation time range.

In the above aircraft reservation system, the available reservation time range setting unit may be configured to set the available reservation time range including the scheduled arrival date and time of the selected flight.

In the above aircraft reservation system, the available reservation time range setting unit may be configured to set the available reservation time range including the scheduled arrival date and time of the selected flight, and the available reservation time range which does not include the scheduled arrival date and time of the selected flight.

In the above aircraft reservation system, the recommended flight extraction unit may be configured to extract the recommended flight from flights for which an improvement in booked percentage is required.

According to the aircraft reservation system, it is possible to support a flight reservation from which both a flight operator and a flight user can benefit.

### BRIEF DESCRIPTION OF THE DRAWINGS

FIG. 1 is a configuration diagram of an aircraft reservation system;

FIG. 2 is an explanatory view of a screen of a reservation application in a first embodiment;

FIG. 3 is a flowchart of a comparison screen display process in the first embodiment;

FIG. 4 is an explanatory view of a screen of a reservation application in a second embodiment;

FIG. 5 is an explanatory view of a mode of switching to an availability screen of the reservation application in the second embodiment; and

FIG. 6 is an explanatory view of a screen of a reservation application in a third embodiment.

### DETAILED DESCRIPTION OF THE PREFERRED EMBODIMENTS

### 1. Configuration of Aircraft Reservation System

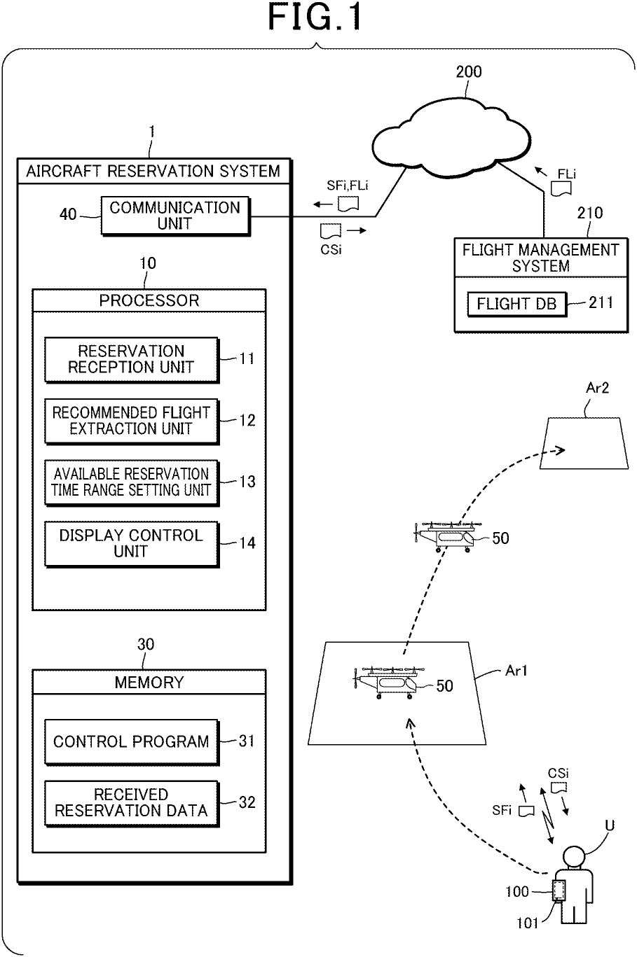

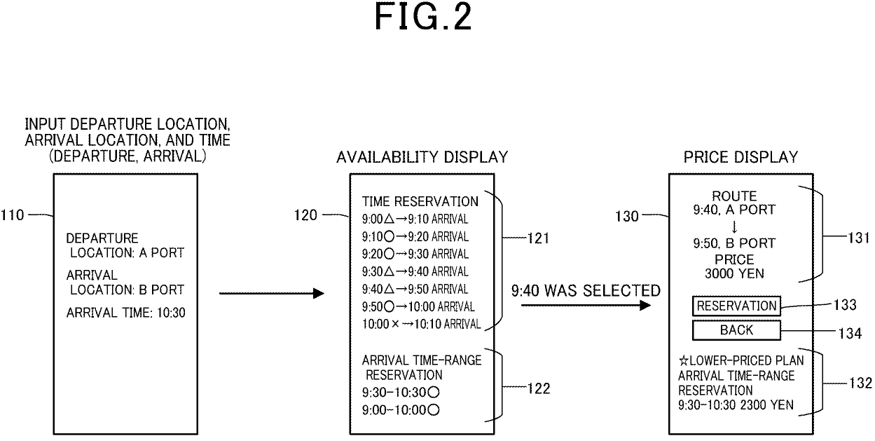

A configuration of an aircraft reservation system 1 of the present embodiment will be described with reference to FIG. 1 and FIG. 2. The aircraft reservation system 1 executes a process for supporting a user U to book a flight of an aircraft 50. The aircraft 50 in the present embodiment is a vertical take-off and landing type aircraft such as a VTOL aircraft, and the number of users who can board the aircraft is, for example, about four people.

The user U books a flight, using a flight reservation application (application program) installed on a user terminal 100. FIG. 1 illustrates an example of a situation in which the user U books and uses a flight of the aircraft 50 from a departure location Ar1 (A port) to an arrival location Ar2 (B port). The user terminal 100 is a communication terminal, such as a smartphone, a mobile phone, a tablet terminal, a notebook personal computer, and a desktop personal computer. The user terminal 100 has a display unit 101 such as a touch panel.

As shown in FIG. 2, the user U inputs, through a reservation requirement input screen 110 of the reservation application displayed on the display unit 101, reservation requirements for a flight that the user U desires to use. The reservation requirements include a desired departure location, a desired arrival location, and a desired arrival date and time. In FIG. 2, the A port, the B port, and 10:30 are input as the desired departure location, the desired arrival location, and the desired arrival time, respectively. Hereinafter, a desired departure date and time, a desired arrival date and time, a scheduled departure date and time, and a scheduled arrival date and time are described as a desired departure time, a desired arrival time, a scheduled departure time, and a scheduled arrival time, respectively, by omitting the dates.

The reservation application displays an availability screen 120 in response to the input of the reservation requirements. In the availability screen 120, a time reservation display 121, and a time-range reservation display 122 are displayed. The time reservation display 121 displays the availability of flights having the same departure location as the desired departure location, the same arrival location as the desired arrival location, and a scheduled arrival time in a range of 9:10 to 10:10 that is not after the desired arrival time (10:30). The time-range reservation display 122 displays the availability of flight reservation based on a specified time range. In the availability screen 120, a circle means that there are plenty of available seats, a triangle means that there are only a few available seats left, and an X means that there are no available seats. Here, in the availability screen 120 of FIG. 2, instead of displaying the time-range reservation display 122, a time-range reservation display 132 that recommends a reservation by a time range may be displayed first upon switching to a comparison screen 130 as will be described later.

FIG. 2 illustrates an example of a situation in which a flight departing at 9:40 and arriving at 9:50 was selected on the availability screen 120. The user terminal 100 transmits selected flight information SFi indicating the flight selected on the availability screen 120 (the selected flight) to the aircraft reservation system 1. The aircraft reservation system 1, upon receiving the selected flight information SFi, transmits, to the user terminal 100, comparison screen information CSi for displaying the comparison screen 130 on the display unit 101.

In the user terminal 100 which has received the comparison screen information CSi, the screen of the display unit 101 is switched from the availability screen 120 to the comparison screen 130 by the reservation application. In the comparison screen 130, a selected flight display 131 displaying the schedule and price of the flight selected (the selected flight), the time-range reservation display 132 displaying the price of a flight based on a specified time range which is set at a lower price than the selected flight, a reservation button 133, and a back button 134 are displayed. The process of switching from the availability screen 120 to the comparison screen 130 will be described later.

The aircraft reservation system 1 communicates between the user terminal 100 and a flight management system 210, or the like, through a communication network 200. The flight management system 210 is a computer system having a processor, a memory, a communication unit, etc., not shown. The flight management system 210 has a flight database (DB) in which flight information FLi including flight plans, reservation status, and prices of a plurality of flights are recorded. The price of each flight varies depending on a booked percentage (actual booked percentage, estimated booked percentage), the number of days left to the scheduled departure date and time, aircraft operating costs, etc.

The aircraft reservation system 1 is a computer system having a processor 10, a memory 30, a communication unit 40, etc. The communication unit 40 communicates between the flight management system 210 and the user terminal 100, or the like, through the communication network 200. In the memory 30, a control program 31 for the aircraft reservation system 1, and received reservation data 32 in which reservation information about a flight requested by the user U is recorded, etc. are stored.

The processor 10 functions as a reservation reception unit 11, a recommended flight extraction unit 12, an available reservation time range setting unit 13, and a display control unit 14 by reading and executing the control program 31. Processing that is performed by the reservation reception unit 11, the recommended flight extraction unit 12, the available reservation time range setting unit 13, and the display control unit 14 will be described later.

### 2. Comparison Screen Display Process in First Embodiment

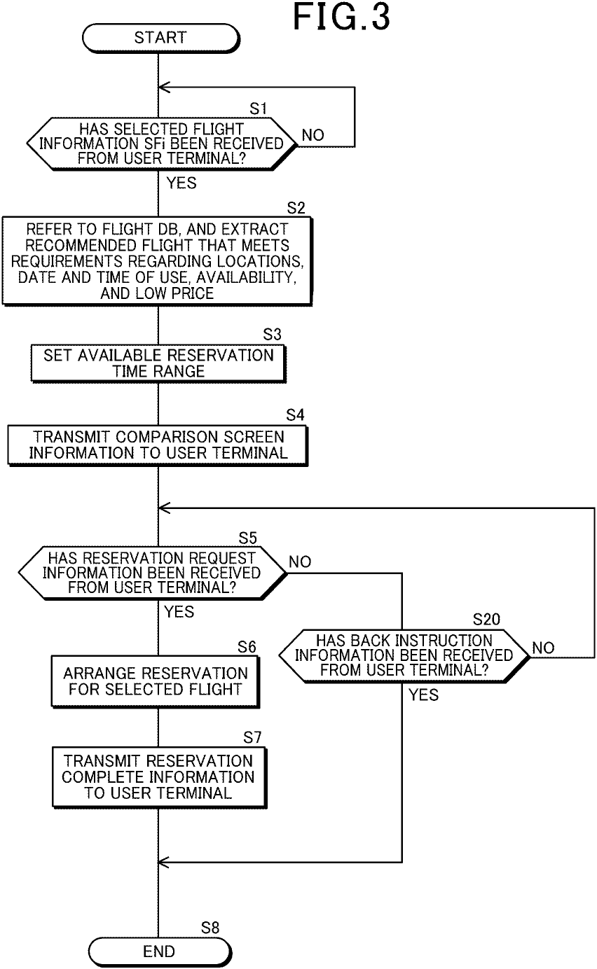

According to a flowchart shown in FIG. 3, the procedure of a reservation support process in the first embodiment, which is executed by the aircraft reservation system 1, will be described with reference to the displays of the screens of the reservation application in FIG. 2.

In step S1 of FIG. 3, when the reservation reception unit 11 has received the selected flight information SFi transmitted from the user terminal 100, the process proceeds to step S2. In step S2, the recommended flight extraction unit 12 accesses a flight DB 211, receives the flight information FLi recorded in the flight DB 211 (see FIG. 1), and recognizes the flight plan, reservation status, and price of each flight. Then, the recommended flight extraction unit 12 extracts a recommended flight that has a departure location and an arrival location same as the selected flight, a scheduled arrival date and time with a difference of not more than a predetermined time from that of the selected flight, and a lower price than the selected flight, and that is available to book.

In the example of FIG. 2, in order to increase the booked percentage for flights with a low booked percentage, for example, the recommended flight extraction unit 12 extracts a flight of 9:50 with an arrival time of 10:00 and plenty of available seats, as a recommended flight. Alternatively, in order to more efficiently operate a flight with a high booked percentage by filling up the seats, the recommended flight extraction unit 12 extracts a flight of 9:00 with an arrival time of 9:10 and only a few available seats left, as a recommended flight.

In the subsequent step S3, the available reservation time range setting unit 13 sets an available reservation time range including the scheduled arrival time of the recommended flight. In the example of FIG. 2, the available reservation time range setting unit 13 sets 9:30-10:30 as an available reservation time range. In the next step S4, the display control unit 14 transmits, to the user terminal 100, the comparison screen information CSi for displaying the comparison screen 130 on the display unit 101 of the user terminal 100.

In the user terminal 100 which has received the comparison screen information CSi, the comparison screen 130 is displayed on the display unit 101 by the reservation application. The user U can check the comparison screen 130, compare the price (3000 yen) of the selected flight displayed in the selected flight display 131 with the price (2300 yen) of a time-range reservation displayed in the time-range reservation display 132, and reconsider the flight to use.

In a subsequent loop process in step S5 and step S20, when the reservation reception unit 11 receives reservation request information according to an operation on the reservation button 133 from the user terminal 100, the process proceeds to step S6. In step S6, if the content of the reservation request information is an instruction to book the selected flight displayed in the selected flight display 131, the reservation reception unit 11 transmits, to the flight management system 210, reservation arrangement information requesting to make an arrangement to book the selected flight. Accordingly, a process for booking the selected flight is executed in the flight management system 210.

If the content of the reservation request information is an instruction to make a reservation by specifying an available reservation time range displayed in the time-range reservation display 132, the reservation reception unit 11 transmits, to the flight management system 210, reservation arrangement information requesting to make an arrangement to book a flight in the available reservation time range. Accordingly, in the flight management system 210, a flight in the available reservation time range that needs to fill available seats is selected, and the process for booking the selected flight is executed. In the next step S7, the reservation reception unit 11 transmits, to the user terminal 100, reservation completion information notifying that the reservation is completed.

Moreover, when the reservation reception unit 11 receives back instruction information according to an operation on the back button 134 from the user terminal 100, the process proceeds to step S8, and is finished. In this case, in the user terminal 100, the screen of the display unit 101 is switched to the availability screen 120 by the reservation application.

### 3. Comparison Screen Display Process in Second Embodiment

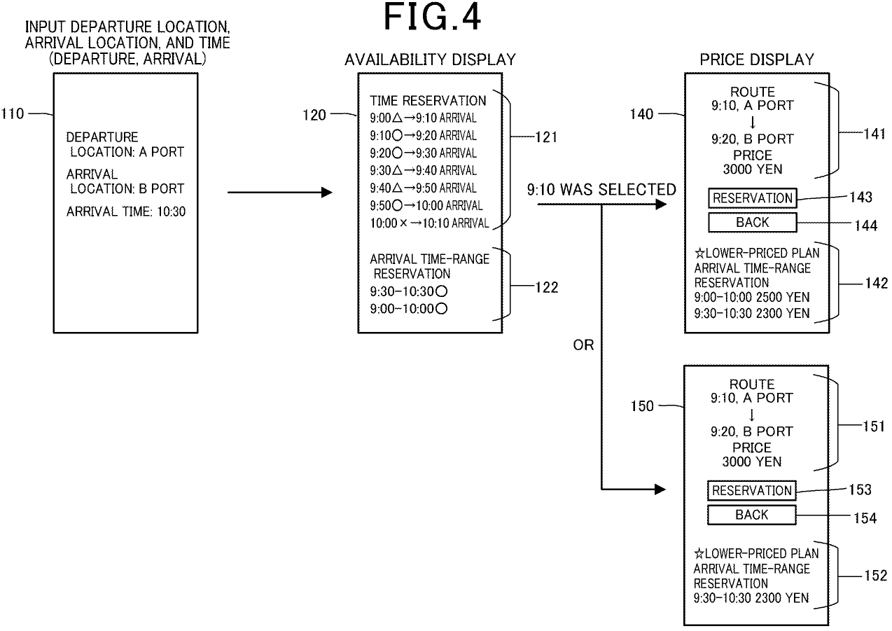

A comparison screen display process in the second embodiment will be described with reference to FIG. 4. A support process in the second embodiment is different from the first embodiment in the setting conditions for an available reservation time range in the available reservation time range setting unit 13. Here, in the availability screen 120 of FIG. 4, instead of displaying the time-range reservation display 122, a time-range reservation display 142 that recommends a reservation by a time range may be displayed first upon switching to a comparison screen 140 as will be described later.

The available reservation time range setting unit 13 sets an available reservation time range including the scheduled arrival time of a selected flight selected by the user U, and an available reservation time range which does not include the scheduled arrival time of the selected flight. Then, the display control unit 14 transmits, to the user terminal 100, the comparison screen information CSi for displaying a comparison screen displaying the available reservation time range including the scheduled arrival time of the selected flight, and the available reservation time range which does not include the scheduled arrival time of the selected flight.

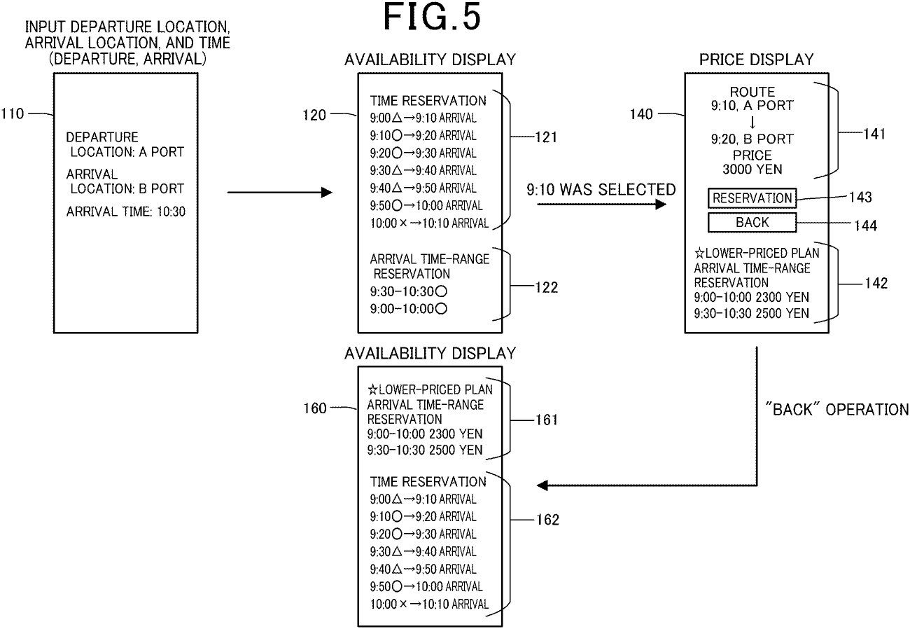

In the example shown in FIG. 5, for a selected flight of 9:10 with an arrival time of 9:20, which was selected by the user U, the available reservation time range setting unit 13 sets an available reservation time range of 9:00-10:00 including the scheduled arrival time (9:20) of the selected flight, and an available reservation time range of 9:30-10:30 which does not include the scheduled arrival time (9:20) of the selected flight.

Then, the display control unit 14 transmits, to the user terminal 100, the comparison screen information CSi for displaying the available reservation time range of 9:00-10:00, and the available reservation time range of 9:30-10:30, and accordingly the comparison screen 140 is displayed on the display unit 101 of the user terminal 100.

In the comparison screen 140, a selected flight display 141 displaying the schedule and price of the selected flight, and the time-range reservation display 142 displaying the available reservation time ranges of 9:00-10:00 and 9:30-10:30 are displayed. The user U can compare the selected flight display 141 with the time-range reservation display 142, take flights with lower prices based on the specified time ranges into consideration, and reconsider the flight to book.

Moreover, the available reservation time range setting unit 13 may set an available reservation time range for a lower price by increasing the period of a time range. A comparison screen 150 in FIG. 4 is an example of this case in which an available reservation time range of 9:00-10:30 is set by the available reservation time range setting unit 13, and is displayed in a time-range reservation display 152.

Further, as shown in FIG. 5, when a back button 144 is operated on the comparison screen 140, the comparison screen information CSi for displaying an availability screen 160, instead of the availability screen 120, may be transmitted to the user terminal 100. In the availability screen 160, a time-range reservation display 161 indicating that the prices of flights based on specified available reservation time ranges are low priced is displayed together with a time reservation display 162.

Note that, in FIG. 5, instead of displaying the time-range reservation display 122 and the time-range reservation display 142 in the availability screen 120 and the comparison screen 140, the time-range reservation display 161 that recommends a reservation by a time range may be displayed first in the availability screen 160 switched according to an operation on the back button 144 by the user U.

### 4. Comparison Screen Display Process in Third Embodiment

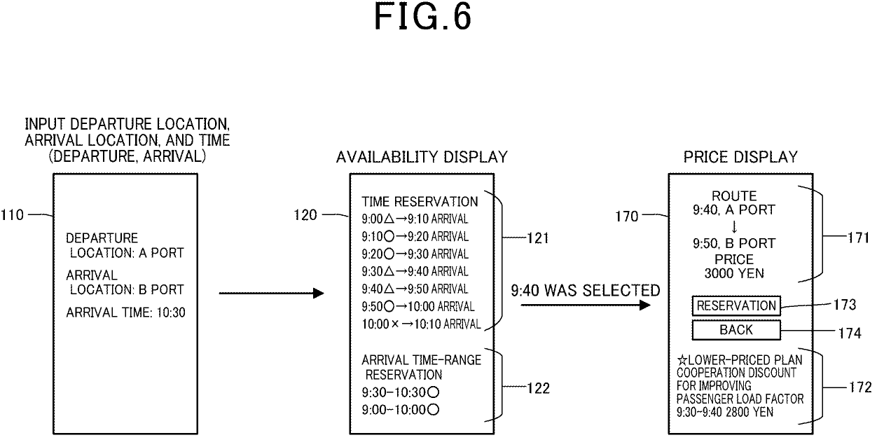

A comparison screen display process in the third embodiment will be described with reference to FIG. 6. In the comparison screen display process in the third embodiment, an available reservation time range is not set, and recommended flight information is displayed. Here, instead of displaying the time-range reservation display 122 in the availability screen 120 of FIG. 6, a recommended flight display 172 that recommends a reservation may be displayed first upon switching to a comparison screen 170 as will be described later.

The display control unit 14 transmits, to the user terminal 100, the comparison screen information CSi for displaying a comparison screen displaying the price of the selected flight and the price of a recommended flight, in a comparable manner, on the display unit 101 of the user terminal 100.

Accordingly, in the example of FIG. 6, the comparison screen 170 is displayed on the display unit 101 of the user terminal 100. In the comparison screen 170, a selected flight display 171 displaying the schedule and usage price of the selected flight selected by the user U, and the recommended flight display 172 displaying the schedule and price of the recommended flight are displayed.

### 5. Other Embodiments

In the above-described embodiments, although an aircraft reservation system of the present disclosure is configured by the aircraft reservation system 1 that communicates with the user terminal 100, the aircraft reservation system of the present disclosure may be configured by the user terminal 100. In this case, the processor equipped in the user terminal 100 functions as the reservation reception unit, the recommended flight extraction unit, the available reservation time range setting unit, and the display control unit by executing the control program installed in the user terminal 100. Alternatively, the configuration of the aircraft reservation system of the present disclosure may be partly provided in the user terminal 100. In this case, the aircraft reservation system of the present disclosure is configured by the aircraft reservation system 1 and the user terminal 100.

In the above embodiments, although the recommended flight extraction unit 12 extracts a recommended flight from flights having scheduled arrival times on or before the scheduled arrival time of the selected flight, a recommended flight may be extracted from flights having scheduled arrival times set within a predetermined time before or after the scheduled arrival time of the selected flight.

In the above embodiments, the recommended flight extraction unit 12 extracts a recommended flight that has a departure location and an arrival location same as the selected flight, a scheduled arrival date and time with a difference of not more than a predetermined time from that of the selected flight, and a lower price than the selected flight, and that is available to book. As another embodiment, the recommended flight extraction unit 12 may extract a recommended flight that has a departure location and an arrival location same as the selected flight, a scheduled departure date and time with a difference of not more than a predetermined time from that of the selected flight, and a lower price than the selected flight, and that is available to book.

Note that, in order to facilitate understanding of the invention of the present application, FIG. 1 is a schematic view showing the functional configuration of the aircraft reservation system 1 by dividing the configuration according to major processing contents, but the configuration of the aircraft reservation system 1 may be configured by other division. Further, the process of each component may be executed by a single hardware unit, or may be executed by a plurality of hardware units. Furthermore, the process of each of components shown in FIG. 2 may be executed by a single program, or may be executed by a plurality of programs.

### 6. Configurations Supported by the Above Embodiments

The above embodiments are specific examples of the following configurations.

(Configuration 1) An aircraft reservation system including: a reservation reception unit that receives a reservation for a flight from a user; a recommended flight extraction unit that refers to a flight database in which flight plans, reservation status, and prices of flights are recorded, and extracts a recommended flight that has a departure location and an arrival location same as a selected flight, a scheduled departure date and time or a scheduled arrival date and time with a difference of not more than a predetermined time from a scheduled departure date and time or a scheduled arrival date and time of the selected flight, and a lower price than the selected flight, and that is available to book, the selected flight being a flight selected by the user, the selection being received by the reservation reception unit; and a display control unit that displays, on a display unit which is visually recognized by the user, a comparison screen displaying, in a comparable manner, the price of the selected flight and the price of the recommended flight.

According to the aircraft reservation system of configuration 1, the user can obtain information on a lower-priced flight, and an aircraft operator can propose a recommended flight that the aircraft operator would like to encourage the user to use, and therefore it is possible to support a flight reservation from which both a flight operator and a flight user can benefit.

(Configuration 2) The aircraft reservation system according to configuration 1, including an available reservation time range setting unit that sets an available reservation time range including the scheduled arrival date and time of the recommended flight, wherein the display control unit displays, on the display unit, the comparison screen displaying, in a comparable manner, the price of the selected flight and a time-range-specified flight price at which a reservation for the recommended flight is arranged in response to specifying the available reservation time range.

According to the aircraft reservation system of configuration 2, by providing the user with information on time-range-specified flights with lower prices than the selected flight, it is possible to provide the user with a wider range of lower-priced flight choices.

(Configuration 3) The aircraft reservation system according to configuration 2, wherein the available reservation time range setting unit sets the available reservation time range including the scheduled arrival date and time of the selected flight.

According to the aircraft reservation system of configuration 3, it is possible to set an available reservation time range that is assumed to be convenient for the user to change from the selected flight.

(Configuration 4) The aircraft reservation system according to configuration 3, wherein the available reservation time range setting unit sets the available reservation time range including the scheduled arrival date and time of the selected flight, and the available reservation time range which does not include the scheduled arrival date and time of the selected flight.

According to the aircraft reservation system of configuration 4, it possible to set an available reservation time range that the user may potentially consider for changing from the selected flight, in addition to the available reservation time range that is assumed to be convenient for the user to change from the selected flight.

(Configuration 5) The aircraft reservation system according to any one of configuration 1 to configuration 4, wherein the recommended flight extraction unit extracts the recommended flight from flights for which an improvement in booked percentage is required.

According to the aircraft reservation system of configuration 5, a flight for which an improvement in booked percentage is required can be proposed as a recommended flight to the user.

### REFERENCE SIGNS LIST

1 ... aircraft reservation system; 10 ... processor; 11 ...reservation reception unit; 12 ... recommended flight extraction unit; 13 ... available reservation time range setting unit; 14 ... display control unit; 30 ... memory; 31 ... control program; 32 ... received reservation data; 40 ... communication unit; 50 ... aircraft; 100 ... user terminal; 101 ... display unit; 110 ... reservation requirement input screen; 120 availability screen; 130, 140, 150, 170 ... comparison screen; 200 ... communication network; 210 ... flight management system; 211 ... flight database (DB); and U ... user.

What is claimed is:

1. An aircraft reservation system comprising:
a reservation reception unit that receives a reservation for a flight from a user;
a recommended flight extraction unit that refers to a flight database in which flight plans, reservation status, and prices of flights are recorded, and extracts a recommended flight that has a departure location and an arrival location same as a selected flight, a scheduled departure date and time or a scheduled arrival date and time with a difference of not more than a predetermined time from a scheduled departure date and time or a scheduled arrival date and time of the selected flight, and a lower price than the selected flight, and that is available to book, the selected flight being a flight selected by the user, the selection being received by the reservation reception unit; and
a display control unit that displays, on a display unit which is visually recognized by the user, a comparison screen displaying, in a comparable manner, the price of the selected flight and the price of the recommended flight.

2. The aircraft reservation system according to claim 1, comprising an available reservation time range setting unit that sets an available reservation time range including the scheduled arrival date and time of the recommended flight, wherein
the display control unit displays, on the display unit, the comparison screen displaying, in a comparable manner, the price of the selected flight and a time-range-specified flight price at which a reservation for the recommended flight is arranged in response to specifying the available reservation time range.

3. The aircraft reservation system according to claim 2, wherein the available reservation time range setting unit sets the available reservation time range including the scheduled arrival date and time of the selected flight.

4. The aircraft reservation system according to claim 3, wherein the available reservation time range setting unit sets the available reservation time range including the scheduled arrival date and time of the selected flight, and the available reservation time range which does not include the scheduled arrival date and time of the selected flight.

5. The aircraft reservation system according to claim 1, wherein the recommended flight extraction unit extracts the recommended flight from flights for which an improvement in booked percentage is required.
